(19) United States
(12) Patent Application Publication
(10) Pub. No.: US 2013/0101724 A1
(43) Pub. Date: Apr. 25, 2013

(54) ESSENTIAL OIL-CONTAINING BEVERAGES

(71) Applicants: Kenryo Kawamoto, Kawasaki-shi (JP); Kyoko Ashikari, Kawasaki-shi (JP)

(72) Inventors: Kenryo Kawamoto, Kawasaki-shi (JP); Kyoko Ashikari, Kawasaki-shi (JP)

(73) Assignee: SUNTORY HOLDINGS LIMITED, Osaka-shi, Osaka (JP)

(21) Appl. No.: 13/699,420

(22) PCT Filed: May 2, 2011
(86) PCT No.: PCT/JP2011/060508

§ 371 Date: Jan. 9, 2013

(30) Foreign Application Priority Data
May 27, 2010 (JP) 2010-122105

(51) Int. Cl. A23L 2/56

(52) U.S. Cl. CPC A23L 2/56
USPC 426/592; 426/590

(57) ABSTRACT

The object of the present invention is to provide a technique that incorporates a relatively large volume of essential oil into a beverage, without spoiling the appearance of the beverage or causing peculiar taste.

Fermented cellulose enables a relatively large volume of essential oil to be contained in a beverage and can suppress the separation of the essential oil in the beverage.

### TECHNICAL FIELD

The present invention relates to essential oil-containing beverages. More specifically, the present invention relates to beverages in which fermented cellulose stably disperses and retains a large volume of essential oil.

### BACKGROUND ART

A variety of flavorings are added to beverages to increase their palatability. Flavorings are largely divided into natural flavorings and synthetic flavorings, and natural flavorings are further divided into animal-derived flavorings and plant-derived flavorings. Among these, flavorings principally used for beverages are plant-derived flavorings.

One of plant-derived flavorings used for beverages is essential oils. Essential oils are volatile liquids collected from plant flowers, buds, fruits, fruit skin, seeds, stems, leaves, bark, rootstock, whole plants, and the like by a method such as steam distillation, cold pressing (expression), or solvent extraction. Essential oils consist primarily of terpene-based compounds such as monoterpenes and sesquiterpenes and aromatic compounds, and differ from fats and oils, which consist primarily of glycerin fatty acid esters.

Since most essential oils are water-insoluble and lighter than water, adding the essential oil directly to beverages causes the floating of oil droplets in a short time because of the difference in specific gravity, and then causes oil layer formation on the liquid surface, consequently spoiling the appearance of the beverages. To avoid such a consequence, various methods are used to water-solubilize essential oils before use of the oils.

A known water-solubilization method is, for example, the method of producing terpeneless oils or water-soluble essences (also referred to as essential flavorings) by removing water-insoluble components such as monoterpenes through reduced pressure distillation, countercurrent extraction, or diluted alcohol extraction. For example, when an aqueous alcohol with 60% alcohol content that contains citrus fruit-derived cold pressed oil is agitated and allowed to stand, the aqueous alcohol is separated into a terpene-containing oil layer portion and a hydroalcoholic portion that contains extracted aroma components. This hydroalcoholic portion is filtered, made transparent, and aged to obtain a citrus fruit-derived essential flavoring.

Other known water-solubilized essential oils are emulsified flavorings that are obtained by use of emulsion stabilizers to emulsify essential oils. Emulsified flavorings serve not only to flavor beverages but also to make them turbid. A general emulsion stabilizer is Arabian gum, and specific gravity modifiers used are natural resins or sucrose fatty acid esters.

However, the aroma components contained in flavorings using the thus water-solubilized essential oils as raw materials are partly removed or enclosed in emulsion stabilizers. As a result, it is sometimes pointed out that the flavorings are deficient in flavor potency and aromatic properties in beverages.

Under these circumstances, to solve the deficiency of the flavor potency or aromatic properties in beverages and provide beverages with fresh and high-impact flavor, the methods of adding essential oils directly to beverages are under consideration. Patent Document 1 discloses a method of dispersing and stabilizing essential oil components in a beverage by adsorbing the essential oil onto water-soluble polysaccharides and/or an emulsifier. Patent Document 2 discloses a method of producing a beverage comprising adding oil flavoring-dispersed liquid sugar obtained by homogenizing the oil flavoring together with a sugar liquid having brix 60 or more. Patent Document 3 discloses that by adding, to an alcoholic beverage, natural fruit-derived essential oil adsorbed onto fruit pulp ground into fine particles, a carbonated alcoholic beverage having the natural fruit-derived aroma can be obtained, and that flavor-enhanced fruit juice also can be obtained. In addition, Patent Document 4 discloses that a carbonated alcoholic beverage not containing much pulp matters can be obtained by dissolving, in syrup, a highly alcoholic flavoring that dissolves an oil-soluble flavoring and then diluting the resulting syrup with water. Patent Document 5 discloses that a carbonated alcoholic beverage having natural fruit-derived aroma can be obtained by the method by which a high-concentration oil flavoring containing a large volume of aroma components is adsorbed and stabilized onto non-sedimenting fruit juice pulp in an alcoholic beverage syrup having a predetermined alcohol concentration.

### CITATION LIST

### Patent Documents

Patent Document 1: JP2008-109900A
Patent Document 2: JP2009-261258A
Patent Document 3: JP2005-124567A
Patent Document 4: WO2005/033260A1
Patent Document 5: JP2006-271334A

### SUMMARY OF INVENTION

### Technical Problem

As described above, conventional flavorings using water-solubilized essential oils have low flavor potency and low aromatic properties in beverages when the flavorings are added thereto. For example, terpeneless oils and essential flavorings have low flavor potency and lack freshness and impact, since their aroma components are partly removed. Emulsified flavorings are poorly aromatic since essential oils contained therein are enclosed in emulsion stabilizers.

To enhance the flavor potency, aromatic properties, freshness, and impact, in beverages, one idea is increasing the volume of a water-solubilized flavoring added to beverages to thereby increase the essential oil content in the beverages.

However, even if an essential oil is water-solubilized, the oil itself is water-insoluble; thus, increasing the loading of a water-solubilized flavoring causes fine oil droplets to be separated out, gather, and finally form an oil layer in a beverage, thus causing various problems. An example of the problems is that, if essential oil contained in syrup that is an intermediate product in a beverage production process is separated out and forms an oil layer on the liquid surface while the syrup is stored in a tank, the phenomenon prevents the filling of containers with a beverage in which the essential oil components of a flavoring used are homogenously dispersed. Even if such filling is possible, there is the possibility that, in products such as packaged beverages, the distribution or storage of which sometimes needs a long period of time, the essential oil contained in the products can be separated out and form an oil layer, greatly decreasing the commercial value of the products. In addition, increasing the loading of an emulsified flavoring is not preferred since the bitter taste of an emulsion stabilizer contained therein becomes perceivable.

Thus, it was not possible to add to beverages a large volume of a flavoring using water-solubilized essential oil, nor was it easy to impart to beverages such fresh and high-impact flavor quality and aromatic properties as to satisfy consumers by increasing the essential oil content in the beverages. It was difficult to incorporate much essential oil into beverages, particularly, low-alcoholic beverages which contain less alcohol, a polar component, and non-alcoholic beverages such as soft drinks, and there was a limitation in providing the beverages with fresh and high-impact flavor.

To solve these technical problems, the methods disclosed in Patent Documents 1 and 2 are insufficient because the loading of essential oil is still not enough and the freshness and impact of the flavor in beverages produced by the methods are also not enough. Concerning the methods disclosed in Patent Documents 3 to 5, essential oil components are adsorbed onto fruit juice-derived fine pulp by the methods, so the pulp can be deposited in products, consequently spoiling their appearance. For this reason, the loading of the pulp is limited and so are the loadings of essential oils in beverages. Further, since the fine pulp used is derived from fruit juice, the scope of application is limited to fruit juice-containing beverages.

As described above, there has not been any known method of incorporating a relatively large volume of essential oil into a beverage while not spoiling the appearance of the beverage and consequently not decreasing commercial value thereof, as well as not causing peculiar taste derived from additives such as emulsion stabilizers.

### Solution to Problem

In view of the problems as described above, the present inventors have intensively studied, and, as a result, they have found that beverages having high flavor potency, aromatic properties, and fresh and high-impact flavor can be produced without any oil layer formation caused by essential oil, for a long time, by using fermented cellulose to stably disperse a relatively large volume of the essential oil in the beverages. The present invention has been thus accomplished.

The present invention includes, but is not limited to, the following inventions:

(1) A beverage comprising fermented cellulose and 0.01 to 1.0 mL essential oil per liter of the beverage.
(2) The beverage of aspect (1), wherein the content of the fermented cellulose is 0.01 to 2.0% w/v.
(3) The beverage of aspect (1) or (2), wherein the essential oil is derived from a citrus fruit.
(4) The beverage of any one of aspects (1) to (3), further comprising 1 to 20% v/v alcohol.
(5) The beverage of any one of aspects (1) to (4), which is a packaged beverage.
(6) A method of producing a beverage, comprising adding a suspension of fermented cellulose in water or aqueous alcohol and 0.01 to 1.0 mL essential oil per liter of a beverage.
(7) The method of aspect (6), further comprising adding the essential oil and the fermented cellulose suspension to prepare a beverage syrup and diluting the syrup to produce a beverage.
(8) The method of aspect (6) or (7), wherein the essential oil is mixed in advance with the fermented cellulose suspension.
(9) The method of aspect (8), further comprising homogenizing the essential oil and the fermented cellulose suspension.
(10) A method of suppressing the separation of essential oil components in a beverage, the method comprising adding fermented cellulose and 0.01 to 1.0 mL essential oil per liter of the beverage.

### Advantageous Effects of Invention

In accordance with the present invention, essential oil is retained in a fermented cellulose three-dimensional network that is uniformly formed throughout a beverage. Thus, even if a relatively large volume of essential oil or flavoring using water-solubilized essential oil is added to a beverage, the essential oil does not separate, float up to the liquid surface of the beverage, or form an oil layer. The addition also can provide the beverage with essential oil-derived fresh and high-impact flavor.

In addition, the three-dimensional network formed in a beverage by fermented cellulose used in the present invention is preferred. The reason is that, unlike polysaccharide thickeners generally used for beverages, the network does not increase the viscosity of beverages, so the beverages can retain essential oil, maintaining smooth fluidity.

Further, it is possible to produce the embodiments of beverages such as ones containing various oily components but no fruit juice, because the present invention enables oily components other than essential oils to be dispersed stably and does not need fruit juice pulp. The present invention also can be applied to beverages containing less or no alcohol such as low- or non-alcoholic beverages, packaged beverages, and the like. This applicability dramatically increases the degree of freedom in product development, so the present invention is very useful. Specifically, the present invention can produce various alcoholic beverages and non-alcoholic beverages, let alone carbonated beverages containing no fruit juice, such as soda pop and cola drinks.

### DESCRIPTION OF EMBODIMENTS

The beverage of the present invention is characterized in that it comprises fermented cellulose and a relatively large volume of essential oil.

Essential Oil

The essential oil as referred to in the present invention is an aromatic volatile liquid collected from plant-based materials such as plant flowers, buds, fruits, fruit skin, seeds, stems, leaves, bark, rootstock, and whole plants by a method such as steam distillation, cold pressing (expression), or solvent extraction. Essential oils contain many compounds such as terpenes, polyterpenes, and phenols. The essential oils for the present invention are liquid at room temperature, and if a large volume of the essential oil is incorporated into a beverage, oil droplets that are separated out can gather and form an oil layer on the liquid surface of the beverage. The essential oils are different from animal fats and oils, which are solid at room temperature, and so-called milk fat, which is enclosed in membrane composed of proteins and glycoconjugates and is dispersed in milk.

The method of collecting the essential oils for the present invention is not particularly limited, and the present invention can use essential oils collected by various methods. For example, the essential oils can be obtained by steam distillation, expression, extraction, aroma recovery, or the like.

The essential oils used in the present invention include not only essential oils themselves but also essential oil components contained in flavorings obtained by water-solubilizing essential oils. For example, the essential oil components may be those contained in essential flavorings and terpeneless oils, which are obtained by solubilizing essential oils in alcohol and removing insoluble components. If a large volume of the essential oil components contained in essential flavorings are added to, in particular, aqueous beverages, the components can be separated out as fine particles and gather and form an oil layer, as described above. Even in this case, the present invention can suppress the oil layer formation.

In the present invention, the essential oil is contained in a volume of 0.01 to 1.0 mL in a 1 L finished beverage, preferably 0.05 to 0.7 mL, more preferably 0.1 to 0.5 mL. When such a volume of the essential oil is used, an oil layer is not formed on the liquid surface of the beverage and consequently the appearance of the beverage is not spoiled, and the essential oil-derived fresh and high-impact flavor can be satisfactorily provided. In terms of stable dispersion in beverages, it is also possible to incorporate 1.0 mL or more essential oil into a finished beverage; however, in this case, the essential oil-derived bitter taste can become markedly perceivable. The volume of the essential oil can be changed depending on the quality characteristics of a beverage that incorporates the essential oil. For example, if a citrus fruit-derived essential oil is used to produce a citrus fruit-flavored beverage or alcoholic beverage, the essential oil is preferably incorporated in a volume of 0.01 to 0.5 mL because the fresh and high-impact flavor of the citrus fruit can be strongly perceived, and more preferably 0.05 to 0.4 mL because the well-balanced flavor of the citrus fruit can be perceived.

The essential oils used in the present invention may be obtained from any plant-based materials, but the essential oils are preferably citrus fruit-derived oils, which are most used in beverages. In the present invention, one essential oil can be used alone or plural essential oils can be used in combination.

When a large volume of essential oil is added to a beverage, the major problem is oil layer formation which spoils the appearance and the like of the beverage. In view of this, the volume of the essential oil in the present invention is intended to be expressed in volume, not in weight. If the weight of essential oil to be used is known, the specific gravity of the essential oil can be used to calculate the volume. For example, in the case of 1 g of lemon oil having a specific gravity of 0.85, the volume can be calculated as follows: 1/0.85=1.18 mL. The loading of essential oil contained in a flavoring can be calculated from the component ratio in the flavoring. For example, in the case of a 2 mL orange oil flavoring having an essential oil content of 14% w/w and a specific gravity of 0.82, the general specific gravity of orange oil, 0.845, can be used to calculate the volume of the essential oil as follows: 0.14×2×0.82/0.845=0.27 mL.

Fermented Cellulose

Fermented cellulose is used in the present invention. Fermented cellulose, which is used in the present invention, is obtained industrially by aerated and agitated culture of acetic acid bacteria and separation and recovery of very thin, fibrous cellulose produced from the bacteria. Marketed products are, for example, SAN ARTIST™ series available from San-Ei Gen F. F. I., Inc. The acetic acid bacteria used for the production of fermented cellulose are, for example, Acetobacter aceti or its subspecies. In terms of the chemical structure of the polysaccharides that constitute fermented cellulose, the polysaccharides are basically β1-4 linked glucose-based straight-chain polymer polysaccharides.

Fermented cellulose in the present invention is water-insoluble and forms a three-dimensional network in a solution. Unlike polysaccharide thickeners, fermented cellulose allows beverages to maintain smooth fluidity since fermented cellulose is low viscosity and less sticky. In addition, fermented cellulose can be stably used with various accompanying components, at various temperatures and pH values, and the like.

Unlike fruit juice pulp (cellulose, i.e., an insoluble polysaccharide), fermented cellulose in the present invention is not deposited and can develop a nearly uniform three-dimensional network throughout a beverage. Thus, even if a large volume of essential oil is incorporated into a beverage, the oil can be stably and homogenously dispersed in the beverage. Another advantageous effect is that good flavor release can be achieved, which makes a flavoring aromatic, probably because fermented cellulose has moderately loose retention of essential oil. Further, the present invention does not need the addition of fruit juice, so the present invention can be applied to beverages containing no or less fruit juice.

To a beverage, fermented cellulose in the present invention is preferably added in the range of 0.01 to 2.0% w/v, more preferably 0.01 to 1.0% w/v, still more preferably 0.01 to 0.5% w/v. The more fermented cellulose in the present invention is added, the more stable the fermented cellulose itself is in a beverage. However, if the content is higher than 2.0% w/v, the viscosity of the beverage is increased, which possibly causes the beverage to depart from the design quality. If the content is lower than 0.01% w/v, a sufficient volume of essential oil cannot be incorporated into a beverage and there is the possibility that the quality that yields sensory satisfaction cannot be attained. Fermented cellulose in the present invention is stably dispersed in beverages, as described above, but it may be used in combination with a polysaccharide thickener to increase the dispersibility of fermented cellulose when the loading of fermented cellulose is high and to stabilize its network. Polysaccharide thickeners can be used without any limitation as long as they are ones generally added to beverages, and one of polysaccharide thickeners can be used alone or two or more of them can be used in combination. Specific examples of the polysaccharide thickener include gelatin, gellan gum, xanthane gum, guar gum, curdlan, fenugreek, carrageenan, and the like. The loading of the polysaccharide thickener is not limited at all as long as the loading does not interfere with the advantageous effects of the present invention.

Prior to being added to a beverage, fermented cellulose in the present invention can be mixed with water or aqueous alcohol. In this case, even only agitation using an agitator is sufficient to prepare the suspension, but a micronization treatment using a homogenizer or the like is preferred because it allows fermented cellulose to fulfill its function sufficiently. The micronization method is not particularly limited, and for example, hydraulic crusher, vibratory ball mill, high-pressure homogenizer, or the like can be used. Among these, the use of a high-pressure homogenizer is preferred from the viewpoint of its convenience and stable production. The pressure of the high-pressure homogenizer, when used, may be within a general range of implementation. Specifically, the pressure is preferably 100 to 300 kg/cm². In the present invention, the timing and order of the addition of the fermented cellulose suspension and essential oil to a beverage are not particularly limited, but they are preferably added prior to syrup production in a process for producing common beverages. The syrup in the present invention refers to a concentrated liquid of a finished beverage and the concentrated liquid is obtained in an intermediate step of a beverage production process and contains raw materials such as sugars, fruit juice, and an acidulant. In many cases, the syrup is subjected to a treatment such as water dilution or carbon dioxide gas injection, to produce finished beverages. The addition of the fermented cellulose suspension and essential oil to beverages in a step prior to the syrup production is preferred because the essential oil can be homogenously dispersed in syrup and beverages having less flavor variation resulting from essential oil can be smoothly produced. Further, in the production of the fermented cellulose suspension, it is preferred to mix essential oil with a suspension in advance and then add the resulting suspension to beverages because the essential oil can be more stably and homogenously dispersed and retained in final beverages. Performing this process together with a micronization treatment using a homogenizer or the like is more preferred because it achieves the state where more finely divided essential oil is stably and homogenously dispersed and retained in fermented cellulose. The micronization method is also not particularly limited, and a hydraulic crusher, vibratory ball mill, high-pressure homogenizer, or the like can be used. Among these, the use of a high-pressure homogenizer is preferred from the viewpoint of its convenience and stable production. The pressure of the high-pressure homogenizer, when used, may be within a general range of implementation. Specifically, the pressure is preferably 100 to 300 kg/cm².

Alcohol

The beverage of the present invention may be either a beverage containing no alcohol or an alcoholic beverage, to which alcohol is added.

The alcohol that can be used in the present invention is not particularly limited. The alcohol is, for example, brewed alcohols, spirits (e.g., spirits such as gin, vodka, rum, tequila, and new spirits, and raw material alcohols), liqueurs, whiskeys (e.g., whiskey, brandy), or shochu (continuous distilled shochu, which is so-called Kou-type shochu, and pot-stilled shochu, which is so-called Otsu-type shochu), as well as brewed liquors such as sake, wines, and beers.

The volume of the alcohol that can be added is not particularly limited. Since essential oils are generally alcohol-soluble, problems resulting from essential oils are likely to occur in low alcohol content beverages. In so-called low-alcoholic beverages, the present invention is highly advantageous and preferred. The range of the alcohol content is preferably 20% v/v or less because the advantageous effects of the present invention can be observed, and more preferably 9% v/v or less, still more preferably 4% v/v or less. If the alcohol content exceeds 20% v/v, the dispersibility of fermented cellulose itself in beverages can be reduced. The lower limit of the alcohol content is not particularly limited, but it is 1% v/v or more in preferred embodiments.

The alcohol content of the beverage of the present invention can be measured with an oscillation-type density meter. A sample is subjected to direct-fire distillation and the density of the resulting distillate is measured at 15° C., and the alcohol content is determined by conversion by reference to “Table 2 Table for Conversion of Alcohol Content, Density (15° C.) and Specific Gravity (15/15° C.)”, which is an appendix table for the analysis method provided by the National Tax Agency (2007 6^{th} Official Instructions by the National Tax Agency, revised on Jun. 22, 2007).

Carbon Dioxide Gas

The beverage of the present invention can contain carbon dioxide gas. The bubble release by the carbon dioxide gas volatilizes a large volume of essential oil components contained in the beverage of the present invention from the liquid surface. Consequently, the fresh and high-impact aroma of the essential oil can be strongly perceived at the time of drinking the beverage or opening the beverage container if the beverage is packaged.

To add carbon dioxide gas, a method generally known by a person skilled in the art may be used. For example, the method may be, but is not limited to, dissolving carbon dioxide in a beverage under pressure, mixing carbon dioxide and a beverage in piping by using a mixer such as a carbonator produced by Tuchenhagen GmbH, absorbing carbon dioxide in a beverage by spraying the beverage into a tank filled with carbon dioxide, or mixing a beverage and carbonated water to produce a carbonated beverage.

The pressure of the carbon dioxide gas in the carbonated beverage of the present invention is preferably such that the refreshingness derived from carbon dioxide gas can be perceived, specifically, 0.5 to 3.0 kg/cm², more preferably 1.5 to 3.0 kg/cm², in accordance with the method for measuring carbon dioxide gas pressure described later.

In the present invention, the carbon dioxide gas pressure was measured with GVA-500A, which is a gas-volume measuring apparatus produced by Kyoto Electronics Manufacturing Co., Ltd. The sample temperature was adjusted to 20° C., and after venting gas (snifting) from the air in containers and shaking the samples, in the gas-volume measuring apparatus, the carbon dioxide gas pressures were measured.

Fruit Juice

The beverage of the present invention can contain a large volume of essential oil, so its fresh and high-impact flavor can be satisfactorily provided. Further, incorporating fruit juice can provide the beverage with more fruit juice-like succulent taste.

Any fruit juice can be used without any limitation as long as it can be used for common beverages, and the fruit juice may be either in the form of straight juice, which directly uses fruit juice obtainable by squeezing fruits, or in the form of concentrated juice, which is obtained by concentration of fruit juice. Turbid juice also can be used and so can whole fruit juice obtained by removing only particularly coarse solids such as seeds after crushing outer skin-containing whole fruit, fruit puree obtained by pureeing fruit, or fruit juice obtained by crushing the pulp of dried fruit or extracting the pulp.

The type of the fruit juice is not particularly limited, and the fruit juice includes, for example, juices of citrus fruits (orange, tangerine, grapefruit, lemon, lime, etc.), apple, grape, peach, tropical fruits (pineapple, guava, banana, mango, acerola, papaya, passion fruit, etc.), other fruits (Japanese apricot, pear, apricot, plum, berries, kiwifruit, etc.), tomato, carrot, strawberry, and melon. Advantageously, the fruit juice is, for example, juices of citrus fruits (orange, tangerine, grapefruit, lemon, lime, etc.), grape, and peach. One of these fruit juices may be used alone or two or more of the fruit juices may be used in combination.

Other Components

In the beverage of the present invention, various components that are commonly incorporated into beverages can be used as long as the components do not reduce the properties of the present invention. Examples of the components that can be incorporated in the present invention include sugars, acids, flavorings, vitamins, dyes, antioxidants, sweeteners, acidulants, emulsifiers, preservatives, seasonings, extracts, pH adjusters, quality stabilizers, and the like.

Packaged Beverages

The alcoholic beverage of the present invention can be packaged. The form of the container used is not limited at all, and the beverage can be supplied in common forms such as molded containers consisting primarily of plastic, metal cans, paper containers comprising a laminate of metal foil and plastic film, and glass bottles. By the present invention, the separation of essential oils in beverages can be suppressed for a long period of time, so packaged beverages for which some time is needed between the production and consumption of the beverages can advantageously greatly benefit from the effects of the present invention.

### EXAMPLES

The present invention will be described below with reference to examples, but is not limited thereto. In the present invention, numerical ranges are intended to include endpoints thereof.

### Example 1

It was examined whether oil layer formation was prevented by incorporating various polysaccharides into a beverage and syrup that is an intermediate product in the beverage production, when a large volume of an essential oil-containing flavoring was added thereto. Oil layer formation in a finished beverage decreases commercial value thereof. Further, if an oil layer is formed in the syrup, which is an intermediate product, in the production of a packaged beverage by use of an in-line blender or the like, the floating essential oil is not uniformly filled into containers, causing flavor variation among products. Thus, it is necessary for an oil layer not to be formed in both a beverage and syrup.

(Preparation of Beverage and Syrup Thereof)

In accordance with Table 1, which shows a formulation, a base liquid for beverage was prepared to which various polysaccharides and an orange oil flavoring (a product of Hasegawa Co., Ltd.; orange essential oil content: 14% w/w) were added at concentrations of 0.04% w/v and 2 mL/L, respectively, in a finished beverage. The volume of the essential oil in the finished beverage was calculated from the orange essential oil content, 14% w/w, the specific gravity of the orange oil flavoring, 0.82, and the general specific gravity of orange oil, 0.845, as follows: 0.14×2×0.82/0.845=0.27 mL/L. The polysaccharides used were fermented cellulose (SAN ARTIST PX, a product of San-Ei Gen F. F. I., Inc.), a water-soluble soybean polysaccharide (SM-1250, a product of the same company), xanthane gum (SAN ACE E-S, a product of the same company), and gellan gum (GEL UP K-S, a product of the same company). In this process, the polysaccharides were added to water or lukewarm water and the resulting mixture was agitated using a homogenizer (homomixer) until the polysaccharides were dissolved. The orange oil flavoring was added thereto, and the resulting mixture was subjected to a micronization treatment using the homogenizer and then added to the foregoing base liquid for beverage.

To the resulting base liquid for beverage, water was added to prepare a syrup and a beverage. The syrup was prepared in a volume of 350 mL; it was concentrated about 2.9-fold relative to a 1000 mL finished beverage. The beverage was prepared by adding pure water to the 350 mL syrup to make a total volume of 1000 mL. The alcohol contents of the syrup and the beverage were 12.3% v/v and 4.3% v/v, respectively.

TABLE 1
Formulation

| | Items | Loadings | |
|---|---|---|---|
| Base Liquid for | 59% v/v alcohol | 72.9 | mL |
| Beverage | Liquid sugar | 100 | g |
| | Clear orange juice concentrate | 3.4 | g |
| | Anhydrous citric acid | 3.2 | g |
| | Sodium citrate | 1 | g |
| | Pure water | appropriate vol. | mL |
| | Polysaccharides | 4 | g |
| | Orange oil flavoring | | |
| | (essential oil content 14%) | 2 | mL |
| | Pure water | appropriate vol. | mL |
| | Pure water | Balance | mL |
| | Total | 200 | mL |
| Syrup | Pure water | approx. 150 | mL |
| | Total | 350 | mL |
| Beverage | Pure water | approx. 650 | mL |
| | Total | 1000 | mL |

The syrup and beverage obtained were allowed to stand still for 24/48/96 hours and observed for the presence or absence of the essential oil content derived from the orange oil flavoring. A sample prepared by adding no polysaccharides but adding only the orange oil flavoring was used as a control.

(Evaluation of Syrup and Beverage)

The syrup and beverage prepared as described above were evaluated in terms of whether an oil layer had been formed and their fluidity. The points and criteria of the evaluation are as follows:

(a) Oil Layer Formation

It was examined whether the essential oil had gathered and formed an oil layer on the surfaces of the syrup and the beverage.

−2: Large-sized essential oil float was observed.
−1: A little essential oil float was observed.
0: No essential oil float was observed.
1: Homogenous dispersion was observed.

(b) Fluidity

Some polysaccharides increase the viscosity of beverages. In light of this, it was examined whether the viscosity had increased enough to make an intended beverage depart from the design quality or to affect the production.

−2: Solidified to form gel
−1: Highly viscous but slightly runny
0: Viscous but acceptable as a beverage
1: Smooth fluidity

(c) Overall Evaluation

The judgment was based on the sum of the scores in (Oil Layer Formation) and (Fluidity). If an oil layer was formed or viscosity increase was observed, the sum of the scores in the both items was 0 or less and it was deemed that the production would be affected or that the commercial value would be lost.

0 or less: The production would be affected in the case of the beverage syrup. No commercial value was recognized in the case of the beverage.
1 or more: The production would not be affected in the case of the beverage syrup. Commercial value was recognized in the case of the beverage.

TABLE 2
Syrup

| | Appearance, | | | | | Water-soluble soybean | | | | | |
|---|---|---|---|---|---|---|---|---|---|---|---|
| | Properties | Control | | Fermented cellulose | | polysaccharide | | Xanthane gum | | Gellan gum | |
| 24 hrs | Oil layer | −2 | Some yellow mass | 1 | Homogenous dispersion | −2 | Some yellow mass | 0 | No essential oil | 0 | No essential oil |
| | formation | | of essential oil | | was observed | | of essential oil | | was observed. | | was observed. |
| | | | was observed. | | throughout syrup. | | was observed. | | | | |
| | Fluidity | 1 | Smooth fluidity | 1 | Smooth fluidity | 1 | Smooth fluidity | −1 | Highly viscous | −2 | Solidified to form |
| | Overall | −1 | Production would | 2 | Production would | −1 | Production would | | Production would | −2 | gel Production |
| | evaluation | | be affected. | | not be affected. | | be affected. | −1 | be affected. | | would be affected. |
| 48 hrs | Oil layer | −2 | Some yellow mass | 1 | Homogenous dispersion | −2 | Some yellow mass | 0 | No essential oil | 0 | No essential oil |
| | formation | | of essential oil | | was observed | | of essential oil. | | was observed. | | was observed. |
| | | | was observed. | | throughout syrup. | | was observed | | | | |
| | Fluidity | 1 | Smooth fluidity | 1 | Smooth fluidity | 1 | Smooth fluidity | −1 | Highly viscous | −2 | Solidified to |
| | | | | | | | | | | | form gel |
| | Overall | −1 | Production would | 2 | Production would | −1 | Production would | −1 | Production would | −2 | Production |
| | evaluation | | be affected. | | not be affected. | | be affected. | | be affected. | | would be affected. |
| 96 hrs | Oil layer | −2 | Some yellow mass | 1 | Homogenous dispersion | −2 | Some yellow mass | 0 | No essential oil | 0 | No essential oil |
| | formation | | of essential oil | | was observed | | of essential oil | | was observed. | | was observed. |
| | | | was observed. | | throughout syrup. | | was observed. | | | | |
| | Fluidity | 1 | Smooth fluidity | 1 | Smooth fluidity | 1 | Smooth fluidity | −1 | Highly viscous | −2 | Solidified to |
| | | | | | | | | | | | form gel |
| | Overall | −1 | Production would | 2 | Production would | −1 | Production would | −1 | Production would | −2 | Production |
| | evaluation | | be affected. | | not be affected. | | be affected. | | be affected. | | would be affected. |

TABLE 3
Beverage

| | Appearance, | | | | | Water-soluble soybean | | | | | |
|---|---|---|---|---|---|---|---|---|---|---|---|
| | Properties | Control | | Fermented cellulose | | polysaccharide | | Xanthane gum | | Gellan gum | |
| 24 | Oil layer | −2 | Some yellow mass | 1 | Homogenous dispersion | −2 | Some yellow mass | 0 | No essential oil | 0 | No essential |
| hrs | formation | | of essential oil | | was observed | | of essential oil | | was observed | | oil was |
| | | | was observed. | | throughout beverage. | | was observed. | | | | observed |
| | Fluidity | 1 | Smooth fluidity | 1 | Smooth fluidity | 1 | Smooth fluidity | −1 | Highly viscous | −2 | Solidfied to form gel |
| | Overall | −1 | No commercial | 2 | Commercial | −1 | No commercial | −1 | No commercial | −2 | No commercial |
| | evaluation | | value was | | value was | | value was | | value was | | value was |
| | | | recognized. | | recognized. | | recognized. | | recognized. | | recognized. |
| 48 | Oil layer | −2 | Some yellow mass | 1 | Homogenous dispersion | −2 | Some yellow mass | 0 | No essential oil | 0 | No essential |
| hrs | formation | | of essential oil | | was observed | | of essential oil | | was observed | | oil was |
| | | | was observed. | | throughout beverage | | was observed. | | | | observed |
| | Fluidity | 1 | Smooth fluidity | 1 | Smooth fluidity | 1 | Smooth fluidity | −1 | Highly viscous | −2 | Solidfied to form gel |
| | Overall | −1 | No commercial | 2 | Commercial | −1 | No commercial | −1 | No commercial | −2 | No commercial |
| | evaluation | | value was | | value was | | value was | | value was | | value was |
| | | | recognized. | | recognized | | recognized. | | recognized. | | recognized. |
| 96 | Oil layer | −2 | Some yellow mass | 1 | Homogenous dispersion | −2 | Some yellow mass | 0 | No essential oil | 0 | No essential |
| hrs | formation | | of essential oil | | was observed | | of essential oil | | was observed | | oil was |
| | | | was observed. | | throughout beverage | | was observed. | | | | observed |
| | Fluidity | 1 | Smooth fluidity | 1 | Smooth fluidity | 1 | Smooth fluidity | −1 | Highly viscous | −2 | Solidfied to form gel |
| | Overall | −1 | No commercial | 2 | No commercial | −1 | No commercial | −1 | No commercial | −2 | No commercial |
| | evaluation | | value was | | value was | | value was | | value was | | value was |
| | | | recognized. | | recognized. | | recognized. | | recognized. | | recognized. |

The results are shown in Tables 2 and 3. These tables show that, when the essential oil was added at a concentration of 0.27 mL per liter of the finished beverage, only the fermented cellulose allowed the essential oil to be dispersed stably and homogenously throughout both the syrup and the beverage and allowed them to keep smooth fluidity. The water-soluble soybean polysaccharide allowed them to keep smooth fluidity, but was inferior to the fermented cellulose in essential oil-retaining volume. The xanthane gum and gellan gum could retain an equivalent volume of the essential oil to the volume in the case of the fermented cellulose, but were inferior to the fermented cellulose in terms of production problems and departure from the design quality because the xanthane gum and gellan gum increased the viscosities of the syrup and the finished beverage. It was revealed that the use of fermented cellulose enables the production of a beverage containing a large volume of essential oil, without causing problems.

### Example 2

In accordance with Table 4, which shows a formulation, a beverage syrup was prepared in a volume of 500 mL; it was concentrated 2-fold relative to a 1000 mL finished beverage, following the same procedure as in Example 1. To this syrup, each of the following materials was added: (a) an orange oil flavoring alone (a product of Hasegawa Co., Ltd.; orange essential oil content: 14% w/w), (b) an orange essential oil-containing transparent emulsified flavoring alone, and (c) fermented cellulose and the orange oil flavoring shown above. Water was added thereto to prepare beverages. At that time, at respective levels of (a), (b), and (c), carbonated beverages which were injected with carbon dioxide gas and beverages that were not injected with carbon dioxide gas were prepared. The orange essential oil content in the orange oil flavoring or the orange essential oil-containing transparent emulsified flavoring was 0.13 mL per liter of the finished beverages. The loading of the fermented cellulose was 0.04% w/v in the finished beverages. It is to be noted that the transparent emulsified flavoring refers to an emulsified flavoring designed to retain its transparent appearance by a homogenization treatment or the like of a common turbid emulsified flavoring to thereby reduce the size of the particles of the flavoring. The alcohol content of the finished beverages was 3.3% v/v and the carbon dioxide gas pressure of the beverages injected with carbon dioxide gas was 1.6 kg/cm².

These samples were evaluated by seven trained expert panelists as follows: concerning the aroma and taste of the finished beverages, an evaluation of their flavor quality was conducted using the control beverages containing (a) the orange oil flavoring alone (3 points). More specifically, 3 points were given to the sample having almost the same quality as the control, 2 points to the sample having a quality somewhat close to the control, and 1 point to the sample quite unlike the control. The means of the evaluation scores given by the panelists were calculated as the evaluation scores for the samples. Further, it was visually observed whether the samples had formed an oil layer when they were syrup; if the floating of the essential oil was observed in any of the samples, the sample was judged as problematic in production and marked with x (cross) and if the floating of the essential oil was not observed, the sample was judged as not problematic in production and marked with ∘ (circle). These evaluation results are shown in Table 5.

TABLE 4
Formulation

| | Items | Loadings | |
|---|---|---|---|
| Syrup | 59% v/v alcohol | 110.8 | mL |
| | Liquid sugar | 120 | g |
| | Clear orange juice concentrate | 4 | g |
| | Anhydrous citric acid | 3.2 | g |
| | Sodium citrate | 1 | g |
| | Pure water | balance | mL |
| | Total | 500 | mL |

TABLE 5
Evaluation

| | | | | (c) Orange oil |
|---|---|---|---|---|
| | | | (b) Transparent | flavoring + |
| | | (a) Orange oil | emulsified | Fermented |
| | | flavoring alone | flavoring alone | cellulose |
| Non- | Aroma | 3 | 1.6 | 2.4 |
| carbonated | Taste | 3 | 2.2 | 2.6 |
| beverage | Oil Layer | x | ∘ | ∘ |
| Carbonated | Aroma | 3 | 1.6 | 2.8 |
| beverage | Taste | 3 | 1.9 | 2.7 |
| | Oil Layer | x | ∘ | ∘ |

The results showed that, even if the loading of the orange oil flavoring alone was so high as to cause the floating of the essential oil in the syrup, the addition of the fermented cellulose prevented such floating and enabled the production of beverages without causing problems. The evaluation results also showed that the aroma and taste of sample (c) were kept close in quality to those of sample (a) and were better than those of sample (b). This tendency was stronger particularly among the carbonated samples. These results revealed that, even when a large volume of an orange oil flavoring is added, fermented cellulose enables the production of beverages without causing problems and allows the beverages to maintain the aroma and taste with a quality close to the original potency of the flavoring. These results also revealed that, if carbon dioxide gas is injected into beverages, a quality closer to the original quality of the flavoring can be achieved.

### Example 3

In accordance with Table 6, which shows a formulation, non-alcoholic beverage syrup was prepared in a volume of 500 mL; it was concentrated 2-fold relative to a 1000 mL finished beverage, following the same procedure as in Example 1. To this syrup, fermented cellulose and an orange oil flavoring (a product of Hasegawa Co., Ltd.; orange essential oil content: 14% w/w) were added. The orange essential oil content in the orange oil flavoring was 0.13 mL per liter of the finished beverage and the loading of the fermented cellulose was 0.04% w/v in the finished beverage. It was visually observed whether the sample had formed an oil layer when it was syrup after the addition of the fermented cellulose and the orange oil flavoring, but the floating of the essential oil was not observed and the sample was judged as not problematic in production.

Water was added to this syrup to prepare non-alcoholic beverages. At that time, a carbonated beverage which was injected with carbon dioxide gas and a beverage that was not injected with carbon dioxide gas were prepared, following the same procedure as in Example 2. Of the finished beverages, the beverage injected with carbon dioxide gas had a carbon dioxide gas pressure of 1.6 kg/cm².

The sensory evaluation of the aroma and taste of these samples was conducted by seven trained expert panelists, using a control non-alcoholic beverage containing only the orange oil flavoring but no fermented cellulose. It was thus confirmed that the both two samples containing the fermented cellulose had flavor close in strength to the flavor of the control sample containing no fermented cellulose. In addition, even in the embodiments of the finished non-alcoholic beverages, the floating of the essential oil was not observed.

TABLE 6
Formulation

| | Items | Loadings | |
|---|---|---|---|
| Syrup | Liquid sugar | 120 | g |
| | Clear orange juice concentrate | 4 | g |
| | Anhydrous citric acid | 3.2 | g |
| | Sodium citrate | 1 | g |
| | Pure water | balance | mL |
| | Total | 500 | mL |

From the above results, it was found that even in the case of non-alcoholic beverages, fermented cellulose suppresses the floating of essential oil, enables the production of the beverages without causing problems, and allows the beverages to maintain the aroma and taste with a quality close to the original potency of a flavoring used, regardless of the presence or absence of carbon dioxide gas.

1. A beverage comprising fermented cellulose and 0.01 to 1.0 mL essential oil per liter of the beverage.

2. The beverage of claim 1, wherein the content of the fermented cellulose is 0.01 to 2.0% w/v.

3. The beverage of claim 1, wherein the essential oil is derived from a citrus fruit.

4. The beverage of claim 1, further comprising 1 to 20% v/v alcohol.

5. The beverage of claim 1, which is a packaged beverage.

6. A method of producing a beverage, comprising adding a suspension of fermented cellulose in water or aqueous alcohol and 0.01 to 1.0 mL essential oil per liter of a beverage.

7. The method of claim 6, further comprising adding the essential oil and the fermented cellulose suspension to prepare a beverage syrup and diluting the syrup to produce a beverage.

8. The method of claim 6, wherein the essential oil is mixed in advance with the fermented cellulose suspension.

9. The method of claim 8, further comprising micronizing the essential oil and the fermented cellulose suspension.

10. A method of suppressing the separation of essential oil components in a beverage, the method comprising adding fermented cellulose and 0.01 to 1.0 mL essential oil per liter of the beverage.
